(19) United States
(12) Patent Application Publication
(10) Pub. No.: US 2025/0350132 A1
(43) Pub. Date: Nov. 13, 2025

(54) Storage and Charging Integrated Device

(71) Applicant: Feng He, Dongguan City (CN)

(72) Inventor: Feng He, Dongguan City (CN)

(21) Appl. No.: 19/013,921

(22) Filed: Jan. 8, 2025

(30) Foreign Application Priority Data
May 12, 2024 (CN) 202421021164.8

(51) Int. Cl. H02J 7/00; H02G 11/02

(52) U.S. Cl. CPC H02J 7/0042; H02G 11/02

(57) ABSTRACT

A storage and charging integrated device is provided, which includes an upper shell and a lower shell that are interlocked, a first PCB conductive board, a locking piece, a toggle piece, and a winding reel. The locking piece and the toggle piece are both provided inside the upper shell and can rotate relative to the upper shell. The toggle piece can toggle the locking piece to rotate, and after rotating at a fixed angle, the locking piece is clamped to the toggle piece. During a rotation process of the winding reel, the toggle piece can be toggled to rotate. This storage and charging integrated device added an additional clamp disk to the basic structure of the existing storage and charging device. The clamp disks can be linked to each other, and the clamp disk can also be linked to a charging cable winding reel.

### CROSS-REFERENCE TO RELATED APPLICATIONS

This application claims priority to Chinese Patent Application No. 202421021164.8, filed on May 12, 2024, which is hereby incorporated by reference in its entirety.

### TECHNICAL FIELD

The present disclosure relates to the field of electronic devices technologies, and in particular, to a storage and charging integrated device.

### BACKGROUND

In daily life, the charging of electronic devices such as mobile phones, tablets, etc. requires adapters and charging cables. The length of the original charging cable is about one meter, and it needs to be manually wound up every time it goes out, which is very troublesome. To solve this problem, a charging cable that can be stored has emerged in the market.

This type of storage charging cable can automatically retract the charging cable, but when the charging cable is pulled to a desired length and a user releases it, the charging cable will be immediately retracted into a housing, which means there is no structure to block the retention. Therefore, a rotatably clamped type of storage and charging integrated device is proposed.

### SUMMARY

In response to the shortcomings of existing technology, the present disclosure provides a storage and charging integrated device, which solves the problems raised by the background technology mentioned above.

To achieve the above objectives, the present disclosure is implemented through the following technical solution: a storage and charging integrated device that is rotatably clamped, including an upper shell and a lower shell that are interlocked, where the storage and charging integrated device further includes:
a first PCB conductive board, which is fixed at a top of an interior of the upper shell;
a locking piece provided inside the upper shell and capable of being rotated relative to the upper shell;
a toggle piece provided in the upper shell and capable of being rotated relative to the upper shell; the locking piece and the toggle piece are stacked together, and the toggle piece is capable of toggling the locking piece to rotate, after rotating a fixed angle, the locking piece is clamped to the toggle piece;
a winding reel, which is rotatably connected to an interior of the lower shell, and during a rotation of the winding reel, the toggle piece is toggled to rotate; and
a second PCB conductive board, which is fixed on an upper of the winding reel and contacts a conductive end of the first PCB conductive board.

In some embodiments of the present disclosure, the storage and charging integrated device further includes:
a spring sheet, which is clamped and fixed on an inner edge of the upper shell, and the spring sheet abuts against the toggle piece.

In some embodiments of the present disclosure, the storage and charging integrated device further includes:
a mainspring, which is provided inside the winding reel; one end of the mainspring is clamped to the upper shell, and the other end thereof is clamped to the winding reel.

In some embodiments of the present disclosure, the storage and charging integrated device further includes:
a charging cable, which is configured to wind outside the winding reel, an input end of the charging cable is fixedly connected to an output end of the winding reel.

In some embodiments of the present disclosure, an inner top of the upper shell is respectively connected to a protruding column, a first central axis, a second central axis, and a spring sheet limit stop block; an end of the protruding column is provided with a limit groove; the locking piece is rotatably connected to an outside of the first central axis, the toggle piece is rotatably connected to an outer side of the second central axis, and the spring sheet is fixedly clamped to an outside of the spring sheet limit stop block.

In some embodiments of the present disclosure, a first through hole is provided in a middle of the first PCB conductive board, a plurality of conductive transition terminals are provided inside the first PCB conductive board; each of the conductive transition terminals is provided with a plurality of conductive pins inside, and a top of the first PCB conductive board is connected to an input terminal.

In some embodiments of the present disclosure, a bottom end of the locking piece is connected to a stop protrusion, two ends of the stop protrusion are provided with a transition groove, and two sides of the stop protrusion are provided with an avoidance groove.

In some embodiments of the present disclosure, an edge of the toggle piece is connected to a clamp protrusion, a top of the toggle piece is respectively provided with a first retention groove and a second retention groove.

In some embodiments of the present disclosure, a bottom end of the winding reel is connected to a winding ring, and a second through hole is provided in a middle of the winding reel; a notch is provided in a section of the winding ring, a bottom of the winding reel that is located outside the second through hole is connected to a winding limit baffle; a top of the winding reel is connected to a locking ring, and a starting groove and a plurality of clamp slots are provided in a section of the locking ring, and an alignment slot is provided on an inner side of the locking ring.

In some embodiments of the present disclosure, a plurality of annular track grooves are provide at a top of the second PCB conductive board, and a conductive bottom plate is provided at a middle of the second PCB conductive board; an edge of the second PCB conductive board is connected to an alignment protrusion, and a bottom of the second PCB conductive board is connected to an output terminal.

The present disclosure provides a storage and charging integrated device that is a rotatably clamped type. Compared with existing technologies, it has the following beneficial effects.

This storage and charging integrated device added an additional clamp disk to the basic structure of the existing charging cable storage device. The clamp disks can be linked to each other, and the clamp disks can also be linked to a charging cable winding reel. An ultimate effect is that when the charging cable is pulled out to a required length, a user releases the charging cable, and under an interlocking effect of the clamp disks, the charging cable will not automatically retract, rendering it more practical.

### BRIEF DESCRIPTION OF DRAWINGS

FIG. 1 is a schematic diagram of a disassembly of the present disclosure.

FIG. 2 is an assembly schematic diagram of the present disclosure.

FIG. 3 is a schematic diagram of an internal structure of an upper shell in the present disclosure.

FIG. 4 is a schematic structural diagram of a first PCB conductive board in the present disclosure.

FIG. 5 is a schematic structural diagram of the upper shell of the present disclosure, which is provided with the first PCB conductive board, a locking piece, a toggle piece, and a spring sheet.

FIG. 6 is a schematic structural diagram of the locking piece in the present disclosure.

FIG. 7 is a schematic structural diagram of the toggle piece in the present disclosure.

FIG. 8 is a schematic structural diagram of a winding reel from a first perspective in the present disclosure.

FIG. 9 is a schematic structural diagram of the winding reel from a second perspective in the present disclosure.

FIG. 10 is a schematic structural diagram of a second PCB conductive board from a first perspective in the present disclosure.

FIG. 11 is a schematic structural diagram of the second PCB conductive board from a second perspective in the present disclosure.

FIG. 12 shows position changes of the locking piece, the second PCB conductive board, and the winding reel during a process of pulling out a charging cable in the present disclosure, as shown in FIG. 1.

FIG. 13 shows position changes of the locking piece, the second PCB conductive board, and the winding reel during the process of pulling out the charging cable in the present disclosure.

Numeral reference: 1-upper shell; 11-protruding column; 12-limit groove; 13-first central axis; 14-second central axis; 15-spring sheet limit stop block; 2-lower shell; 3-first PCB conductive board; 31-input terminal; 32-conductive transition terminal; 33-conductive pin; 34-first through hole; 4-locking piece; 41-stop protrusion; 42-transition groove; 43-avoidance groove; 5-toggle piece; 51-clamp protrusion; 52-first retention groove; 53-second retention groove; 6-spring sheet; 7-winding reel; 71-winding ring; 72-second through hole; 73-notch; 74-winding limit baffle; 75-locking ring; 76-starting groove; 77-clamp slot; 78-alignment slot; 8-second PCB conductive board; 81-conductive bottom plate; 82-alignment protrusion; 83-annular track groove; 84-output terminal; 9-mainspring; 10-charging cable.

### DESCRIPTION OF EMBODIMENTS

The following will provide a clear and complete description of the technical solution in the embodiments of the present disclosure, based on the accompanying drawings. Obviously, the described embodiments are only a part of the embodiments of the present disclosure, not all of them. Based on the embodiments in the present disclosure, all other embodiments obtained by those skilled in the art without creative work are within the protection scope of the present disclosure.

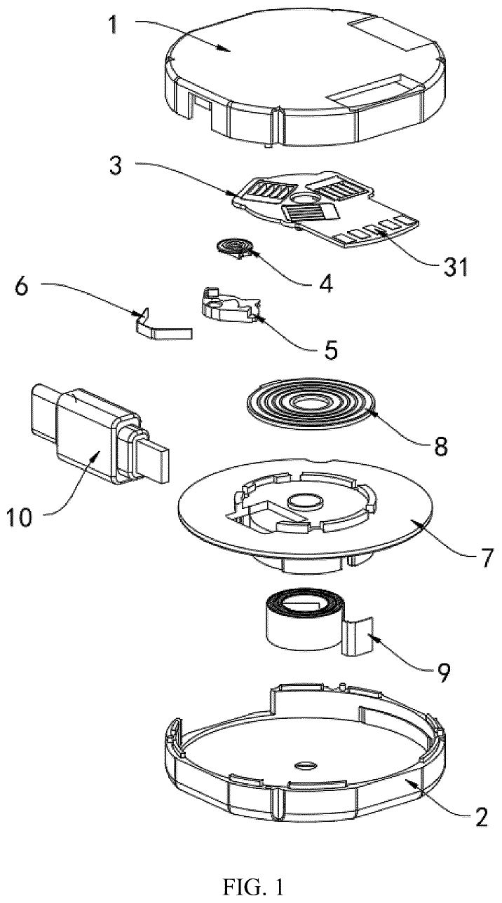

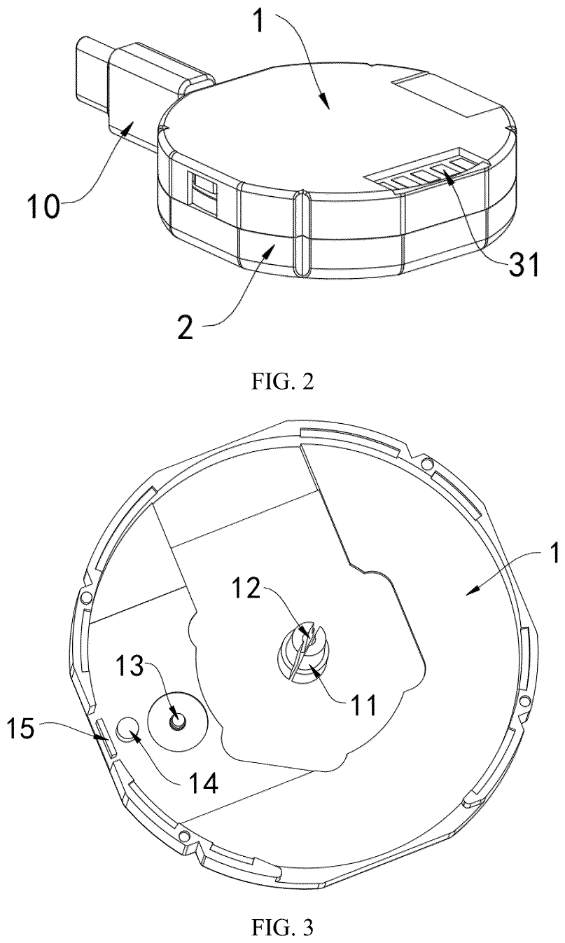

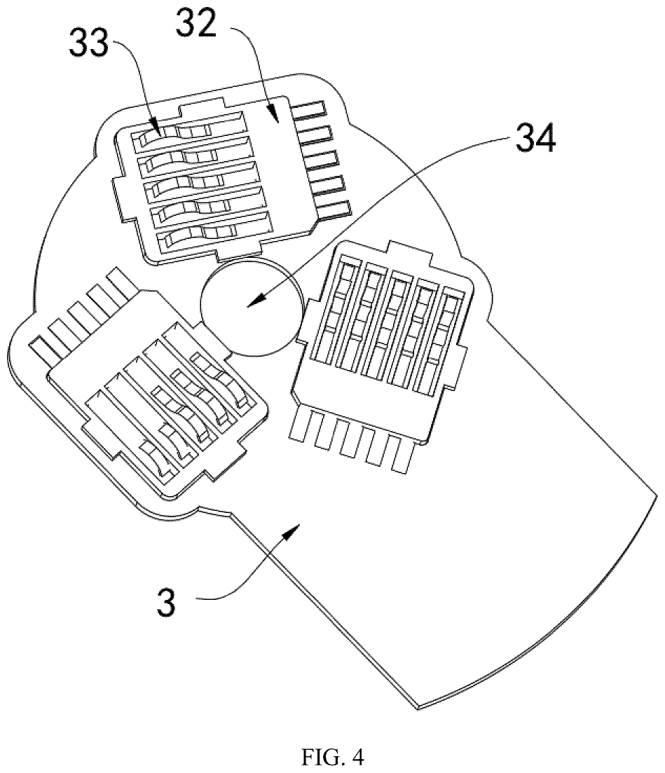

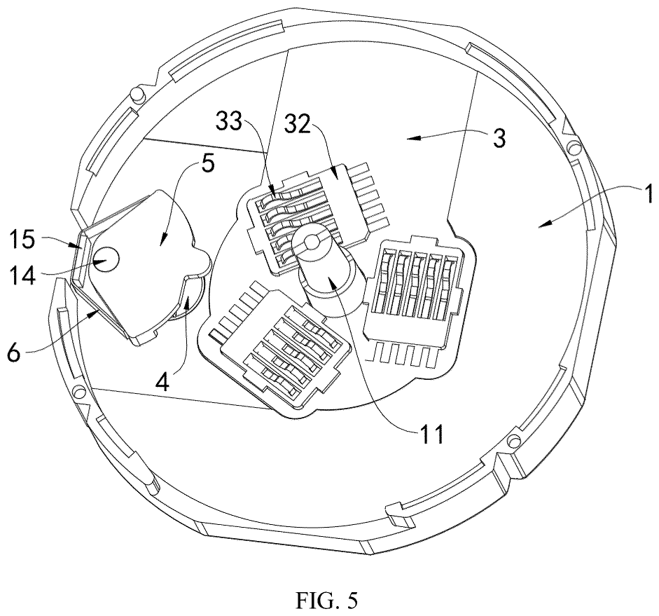

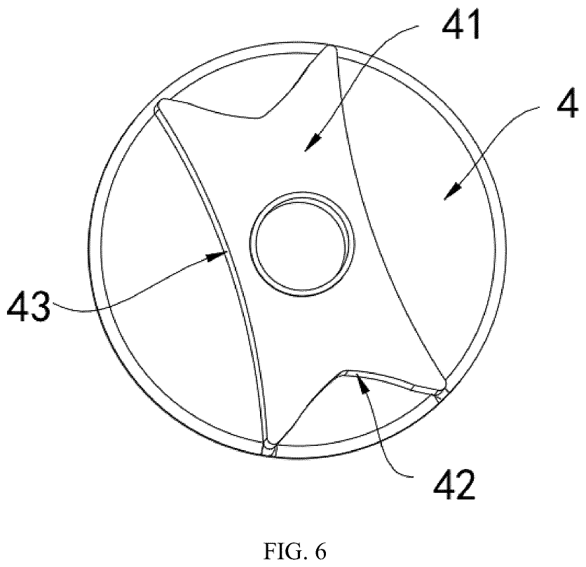

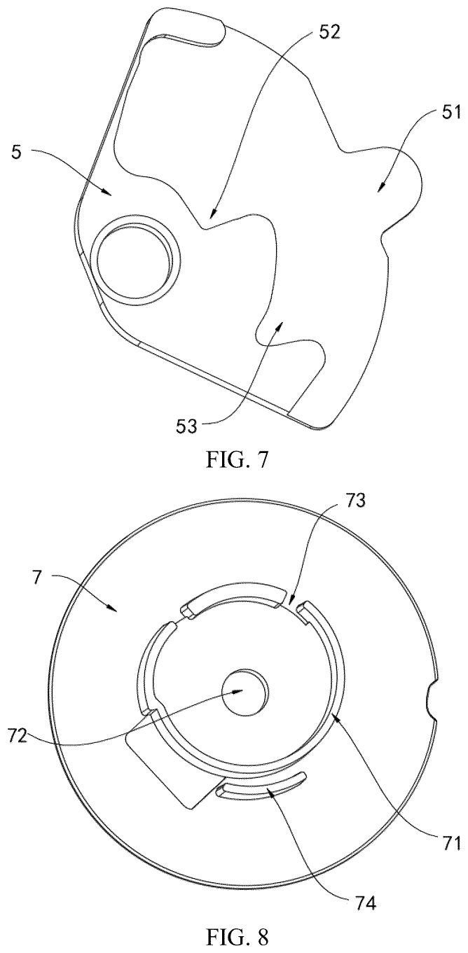

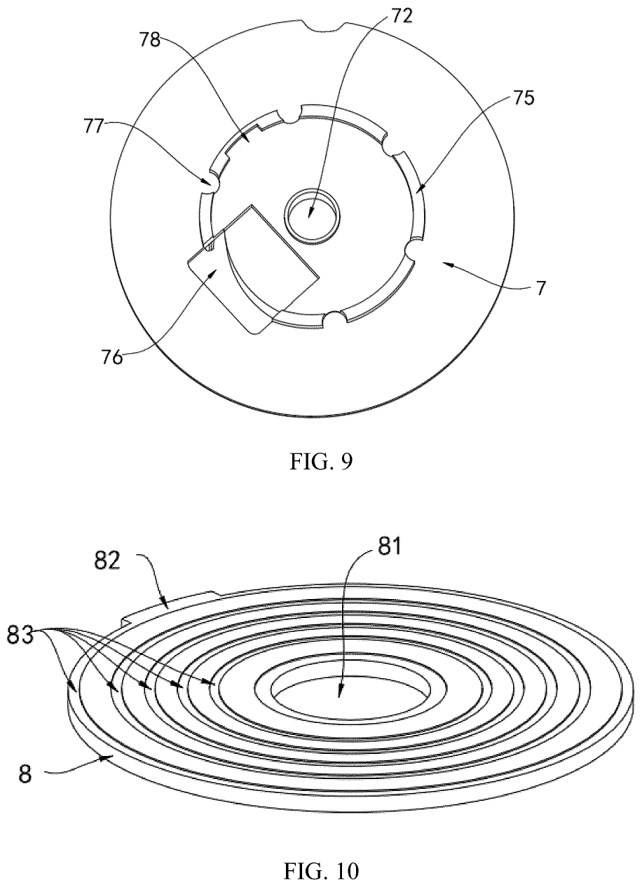

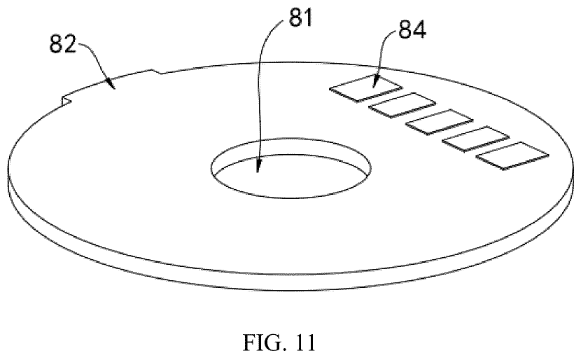

Please refer to FIGS. 1-11, the present disclosure provides a technical solution: a storage and charging integrated device that is rotatably clamped type, which is composed of a housing, a first PCB conductive board 3, a locking piece 4, a toggle piece 5, a spring sheet 6, a winding reel 7, a second PCB conductive board 8, a mainspring 9, and a charging cable 10. The housing is made of insulating material and is formed by fastening an upper shell 1 and a lower shell 2. After the housing is formed, an opening is provided on a side of the housing to expose an output end of a charging cable 10 from an inside of the housing.

A protruding column 11, a first central axis 13, a second central axis 14, and a spring sheet limit stop block 15 are formed as a whole inside the upper shell 1. The protruding column 11 is extended towards a direction of the lower shell 2, and a limit groove 12 is provided at an end of the protruding column 11 to restrain one end of the mainspring 9. That is, one end of the mainspring 9 is inserted into the limit groove 12, the locking piece 4 is sleeved outside the first central axis 13, and they can rotate relative to each other. The toggle piece 5 is eccentrically sleeved outside the second central axis 14, and they can also rotate relative to each other. The locking piece 4 and the toggle piece 5 are distributed in a stacked manner, and the spring sheet 6 is clamped and fixed outside the spring sheet limit stop block 15. At the same time, the spring sheet 6 is wrapped around an outside of the toggle piece 5. When the toggle piece 5 is rotated, one end of the spring sheet 6 will be compressed and deformed.

The first PCB conductive board 3 is fixed at a top of an interior of the upper shell 1 and sleeved on an outer side of the protruding column 11. An input terminal 31 is provided at a top of the first PCB conductive board 3, and an opening is provided at a top of the upper shell 1 to expose an input terminal 31. There are three conductive transition terminals 32 fixed inside the first PCB conductive board 3, and five conductive pins 33 are fixed inside each of the conductive transition terminals 32. One end of each conductive pin 33 is protruded from the conductive transition terminals 32.

In addition, to ensure that the circuit is conductive, a second PCB conductive board 8 is wound the winding reel 7 and fixed at a top of the winding reel 7. A top of the second PCB conductive board 8 is provided with five annular track grooves 83. When the second PCB conductive board 2 is rotated with the winding reel 7 and rotated relative to the first PCB conductive board 3, a protruding end of the conductive pin 33 is always located in a corresponding annular track groove 83, that is, always in contact to ensure conductivity. A bottom end of the second PCB conductive board 8 is provided with an output terminal 84, which is fixedly connected to an input end of the charging cable 10 through welding.

The winding reel 7 is rotatably provided outside the protruding column 11. A bottom of the winding reel 7 is integrally formed with a winding ring 71, and a winding limit baffle 74 is provided around the winding ring 71. A wire part of the charging cable 10 is wound outside the winding ring 71 and is constrained by the winding limit baffle 74. A notch 73 is provided on the winding ring 71, and the mainspring 9 is located inside the winding ring 71, the other end of the mainspring 9 is inserted inside the notch 73.

A top of the winding reel 7 is integrally formed with a locking ring 75, which has an open area that is provided with a starting groove 76. A plurality of clamp slots 77 are evenly distributed on an outer side of other areas of the locking ring 75. The second PCB conductive board 8 is fixed inside the locking ring 75, and an alignment slot 78 is provided on an inner side of the locking ring 75. An edge of the second PCB conductive board 8 is integrally formed with an alignment protrusion 82, the alignment protrusion 82 is clamped inside the alignment slot 78.

A bottom of the locking piece 4 is integrally formed with a stop protrusion 41, and two ends of the stop protrusion 41 are provided with “V”-shaped transition grooves 42. Two sides of the stop protrusion 41 are provided with an arc-shaped avoidance groove 43, the “V”-shaped transition grooves 42 and the arc-shaped avoidance grooves 43 cause four corners of the stop protrusion 41 to form a convex structure. An edge of the toggle piece 5 is integrally formed with a clamp protrusion 51, and a sinking groove that can accommodate the locking piece 4 is provided at a top of the toggle piece 5. A first retention groove 52 and a second retention groove 53 are respectively provided at an edge of the sinking groove.

Finally, it should be noted that middles of the first PCB conductive board 3, the winding reel 7, and the second PCB conductive board 8 are respectively provided with a first through hole 34, a second through hole 72, and a third through hole 81. After the protruding column 11 passes through the first through hole 34, the second through hole 72, and third through hole 81 in sequence, the limit groove 12 provided at its end is clamped to one end of the mainspring 9.

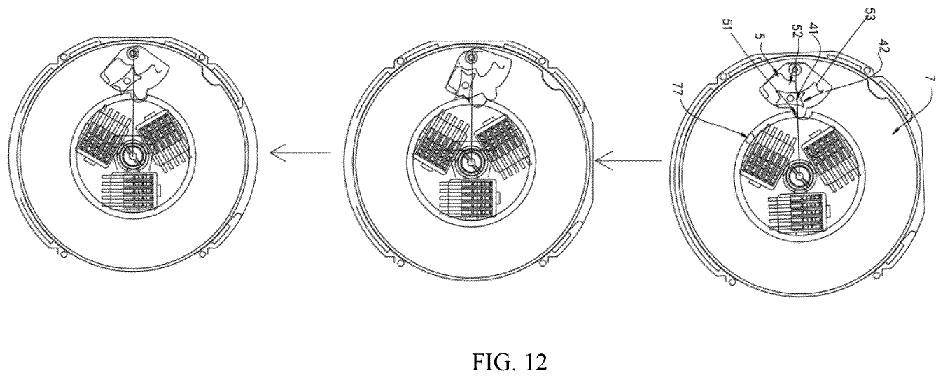

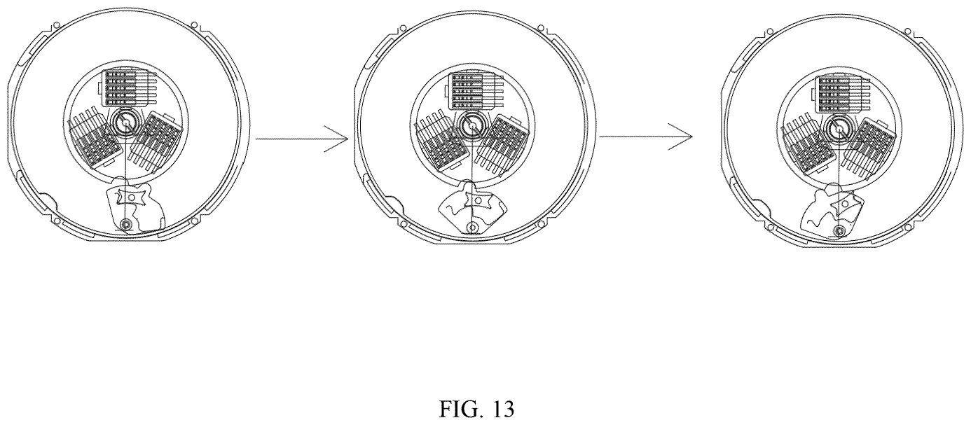

Please refer to FIGS. 12 and 13. At the beginning, the clamp protrusion 51 is located in the starting groove 76, a protruding structure of the “V”-shaped transition groove 42 is located inside the first retention groove 52 (as shown in a lower left corner of FIG. 12). During a process of pulling out the charging cable 10, the charging cable 10 pulls the winding reel 7 to rotate clockwise, causing the mainspring 9 to contract under force. At the same time, the locking ring 75 on one side of the starting groove 76 will approach the clamp protrusion 51. As the charging cable 10 continues to be pulled, the clamp protrusion 51 will abut against the locking ring 75 (as shown in an upper left corner of FIG. 12), and the locking ring 75 will abut against the clamp protrusion 51, causing the toggle piece 5 to rotate counterclockwise around the central axis 214 as a rotation point. At this time, one end of the spring sheet 6 will also be compressed and deformed. When the edge of the locking ring 75 is tangent to the clamp protrusion 51 (as shown in an upper right corner of FIG. 12), the toggle piece 5 is rotated counterclockwise, the protruding structure of the “V”-shaped transition groove 42 is located inside the second retention groove 53, the protruding structure is still inside the second retention groove 53 until the locking ring 75 is rotated when a certain clamp slot 77 is clamped to the clamp protrusion 51. At this time, if a length of the charging cable 10 meets an usage requirements, a user will release the charging cable 10, and the charging cable 10 will not automatically retract. To retract the charging cable 10, the user needs to first pull the charging cable 10 outward for a small distance to separate the clamp protrusion 51 from the clamp slot 77, and the protruding structure is also separated from the second retention groove 53, when releasing the charging cable 10, under an action of the mainspring 9, the winding reel 7 will immediately rotate counterclockwise, thereby winding the charging cable 10. Locking and avoiding of the locking piece 4 are achieved by the toggle piece 5 and the clamp slot 77.

After winding and pulling the charging cable 10, it will not affect charging because during a rotation of the winding reel 7, the second PCB conductive board 28 is also rotated synchronously. The conductivity between the second PCB conductive board 8 and the first PCB conductive board 3 is achieved through the annular track groove 83 that is slid and the plurality of conductive pins 33 when in contact, so it will not affect charging work.

What is claimed is:

1. A storage and charging integrated device that is rotatably clamped, comprising an upper shell and a lower shell that are interlocked,
wherein the storage and charging integrated device further comprises:
a first PCB conductive board, which is fixed at a top of an interior of the upper shell;
a locking piece provided inside the upper shell and capable of being rotated relative to the upper shell;
a toggle piece provided in the upper shell and capable of being rotated relative to the upper shell; the locking piece and the toggle piece are stacked together, and the toggle piece is capable of toggling the locking piece to rotate, after rotating a fixed angle, the locking piece is clamped to the toggle piece;
a winding reel, which is rotatably connected to an interior of the lower shell, and during a rotation of the winding reel, the toggle piece is toggled to rotate; and
a second PCB conductive board, which is fixed on an upper of the winding reel and contacts a conductive end of the first PCB conductive board.

2. The storage and charging integrated device according to claim 1, further comprising:
a spring sheet, which is clamped and fixed on an inner edge of the upper shell, and the spring sheet abuts against the toggle piece.

3. The storage and charging integrated device according to claim 1, further comprising:
a mainspring, which is provided inside the winding reel;
one end of the mainspring is clamped to the upper shell, and the other end thereof is clamped to the winding reel.

4. The storage and charging integrated device according to claim 1, further comprising:
a charging cable, which is configured to wind outside the winding reel,
an input end of the charging cable is fixedly connected to an output end of the winding reel.

5. The storage and charging integrated device according to claim 1, wherein an inner top of the upper shell is respectively connected to a protruding column, a first central axis, a second central axis, and a spring sheet limit stop block;
an end of the protruding column is provided with a limit groove;
the locking piece is rotatably connected to an outside of the first central axis,
the toggle piece is rotatably connected to an outer side of the second central axis, and the spring sheet is fixedly clamped to an outside of the spring sheet limit stop block.

6. The storage and charging integrated device according to claim 1, wherein a first through hole is provided in a middle of the first PCB conductive board,
a plurality of conductive transition terminals are provided inside the first PCB conductive board;
each of the conductive transition terminals is provided with a plurality of conductive pins inside, and
a top of the first PCB conductive board is connected to an input terminal.

7. The storage and charging integrated device according to claim 1, wherein a bottom end of the locking piece is connected to a stop protrusion, two ends of the stop protrusion are provided with a transition groove, and
two sides of the stop protrusion are provided with an avoidance groove.

8. The storage and charging integrated device according to claim 1, wherein an edge of the toggle piece is connected to a clamp protrusion,
a top of the toggle piece is respectively provided with a first retention groove and a second retention groove.

9. The storage and charging integrated device according to claim 1, wherein a bottom end of the winding reel is connected to a winding ring, and a second through hole is provided in a middle of the winding reel;
a notch is provided in a section of the winding ring,
a bottom of the winding reel that is located outside the second through hole is connected to a winding limit baffle;
a top of the winding reel is connected to a locking ring, and a starting groove and a plurality of clamp slots are provided in a section of the locking ring, and an alignment slot is provided on an inner side of the locking ring.

10. The storage and charging integrated device according to claim 1, wherein a plurality of annular track grooves are provided at a top of the second PCB conductive board, and a conductive bottom plate is provided at a middle of the second PCB conductive board;
an edge of the second PCB conductive board is connected to an alignment protrusion, and a bottom of the second PCB conductive board is connected to an output terminal.
